(19) United States
(12) Patent Application Publication
(10) Pub. No.: US 2018/0322796 A1
(43) Pub. Date: Nov. 8, 2018

(54) A/B TESTING FOR MASSIVE OPEN ONLINE COURSES

(71) Applicant: COURSERA, INC., Mountain View, CA (US)

(72) Inventor: Amory B. SCHLENDER, San Francisco, CA (US)

(21) Appl. No.: 15/969,241

(22) Filed: May 2, 2018

Related U.S. Application Data
(60) Provisional application No. 62/500,833, filed on May 3, 2017.

(51) Int. Cl. G09B 5/08; G06F 7/58; G09B 5/06

(52) U.S. Cl. CPC G09B 5/08; G09B 19/025; G09B 5/065; G06F 7/588

(57) ABSTRACT

Techniques of randomized testing of massively open online courses (MOOCs) involve generating independent A/B tests on the plurality of individual sections of a MOOC. Along these lines, a MOOC may have many learning modules, with many students enrolled in the MOOC. A course instructor may wish to experiment with different variations of course content in order to discover whether any such variations may improve the MOOC. Rather than perform a single A/B test during the MOOC to obtain results for which the course instructor would have to wait weeks, the instructor submits variations of various individual learning modules of the MOOC to a A/B testing server. The A/B testing server may then assign students in each lecture to different versions of a learning module. The A/B testing server may also evaluate the results of the testing in order to provide a recommendation about the MOOC as a whole.

### RELATED APPLICATION

This Application claims priority to and the benefit of U.S. Provisional Application No. 62/500,833, filed May 3, 2017, entitled, “A/B TESTING FOR MASSIVE OPEN ONLINE COURSES,” which is incorporated herein by reference in its entirety.

### TECHNICAL FIELD

This description relates to testing content variations for massive open online courses (MOOCs).

### BACKGROUND

MOOCs include course materials on various media such as text documents, audio, and video that contain the course content. Students follow a protocol for studying the course content in order to master the subject matter of a course. The students evaluate their mastery of the subject matter through tests, homework, and other projects.

A/B testing involves a controlled experiment with two variants, A and B, which are a control and a variation in the experiment. For example, two versions (A and B) of a website are compared, which are identical except for one variation (e.g., size of a title on a page) that might affect a user's behavior. Version A might be the currently used version (control), while version B is modified in some respect (treatment).

### SUMMARY

In one general aspect, a method can include obtaining, by processing circuitry of a computer, massive open online course (MOOC) data and data describing a population of students enrolled in the MOOC, the MOOC data including data describing a plurality of learning modules of the MOOC, each of the plurality of learning modules including respective first course content and second course content. The method can also include, for each of the plurality of learning modules, assigning a first portion of the population of students to experience that learning module with the respective first course content and a second portion of the population of students to experience that learning module with the respective second course content. The method can also include, for each of the plurality of learning modules, performing a short-timescale evaluation operation on that learning module based on a specified metric applied to the first portion of the population of students and the second portion of the population of students to produce evaluation results for that learning module.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram that illustrates an example electronic environment according to an implementation of improved techniques described herein.

FIG. 2 is a flow chart illustrating an example method according to the improved techniques described herein.

FIG. 3A is a diagram illustrating an example experiment according to the improved techniques described herein.

FIG. 3B is a diagram illustrating another example experiment according to the improved techniques described herein.

### DETAILED DESCRIPTION

Conventional approaches to randomized testing of massive open online courses (MOOCs) involve performing A/B testing on a single aspect of a MOOC in a similar fashion as a website. Nevertheless, the conventional approaches to randomized testing of MOOCs is burdensome for those involved in the experiment, i.e., teachers and students, because, unlike a website in which a purchase is made in seconds or minutes, a typical MOOC takes between four and ten weeks to complete.

In contrast to the above-described conventional approaches to randomized testing of MOOCs that are not suited for the timescale of a typical course, improved techniques involve generating independent A/B tests on the plurality of individual sections of a MOOC. Along these lines, a MOOC may have many learning modules, with many students enrolled in the MOOC. A course instructor may wish to experiment with different variations of course content in order to discover whether any such variations may improve the MOOC. Rather than perform a single A/B test during the MOOC to obtain results for which the course instructor would have to wait weeks, the instructor submits variations of various individual learning modules of the MOOC to a A/B testing server. The A/B testing server may then assign students in each lecture to different versions of a learning module. The A/B testing server may also evaluate the results of the testing in order to provide a recommendation about the MOOC as a whole.

Advantageously, each individual A/B test provides a relatively fast turnaround time for evaluating variations of sections of a MOOC, while a totality of the independent A/B tests provides a meaningful evaluation of the MOOC as a whole.

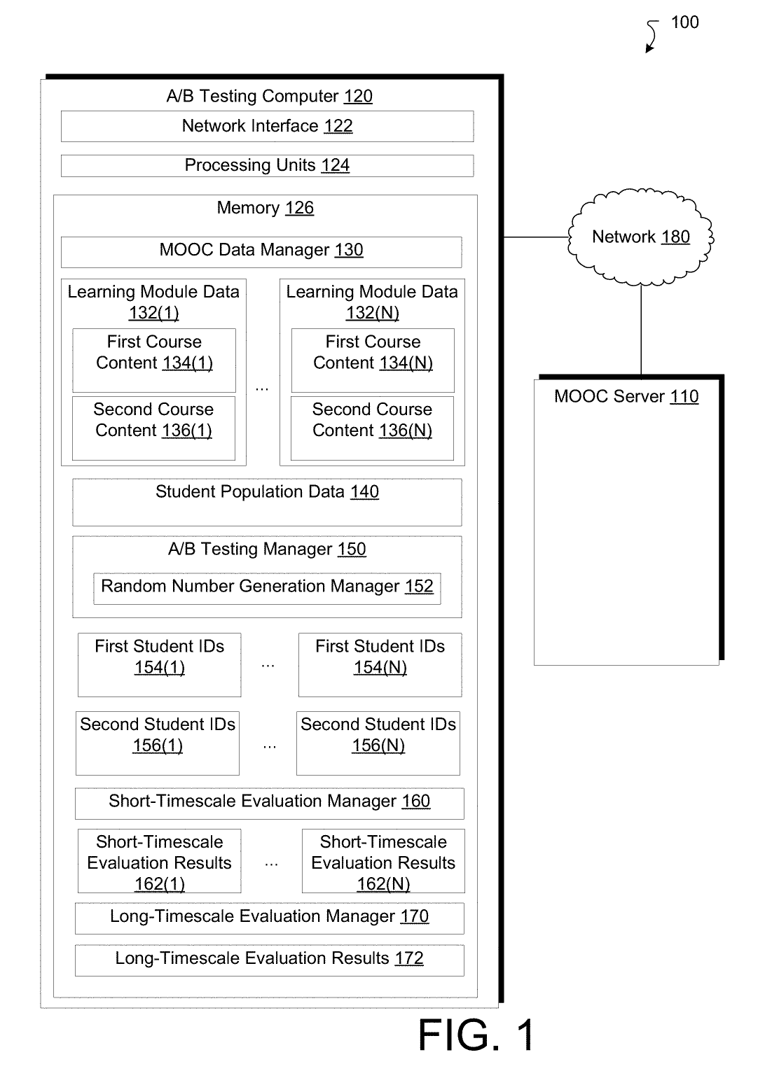

FIG. 1 is a diagram that illustrates an example electronic environment 100 in which the above-described improved techniques may be implemented. As shown, in FIG. 1, the example electronic environment 100 includes a MOOC server 110 that hosts the MOOC, an A/B testing computer 120, and a network 180.

The A/B testing computer 120 is configured to perform A/B testing on learning modules of a MOOC hosted by the MOOC server 110. The A/B testing computer 120 includes a network interface 122, one or more processing units 124, and memory 126. The network interface 122 includes, for example, Ethernet adaptors, Token Ring adaptors, and the like, for converting electronic and/or optical signals received from the network 180 to electronic form for use by the A/B testing computer 120. The set of processing units 124 include one or more processing chips and/or assemblies. The memory 126 includes both volatile memory (e.g., RAM) and non-volatile memory, such as one or more ROMs, disk drives, solid state drives, and the like. The set of processing units 124 and the memory 126 together form control circuitry, which is configured and arranged to carry out various methods and functions as described herein.

In some embodiments, one or more of the components of the A/B testing computer 120 can be, or can include processors (e.g., processing units 124) configured to process instructions stored in the memory 126. Examples of such instructions as depicted in FIG. 1 include a MOOC data manager 130, an A/B testing manager 150, a short-timescale evaluation manager 160, and a long-timescale evaluation manager 170. Further, as illustrated in FIG. 1, the memory 126 is configured to store various data, which is described with respect to the respective managers that use such data.

The MOOC data manager 130 is configured to acquire and store in the memory 126 data defining a MOOC such as learning module data 132(1), . . . , 132(N) and student population data 140. Along these lines, the MOOC that is being evaluated by the A/B testing computer 120 has multiple (N) learning modules. Each of the learning modules, e.g., 132(k), 1<=k<=N, includes respective first course content 134(k). In some implementations, the first course content 134(k) of a learning module 132(k) includes one or more videos, typically showing lectures given online by a course instructor, as well as textual documents for reading, homework, and quizzes.

The learning module 132(k) as stored in memory 126 also includes second course content 136(k). Second course content 136(k) includes a different version of at least one of the videos or textual documents of the first course content 134(k). Typically, the course instructor will create the second course content 136(k) as well as the first course content 134(k). Nevertheless, in some implementations, the A/B testing computer 120 is configured to automatically generate the second course content 136(k) from the first course content 134(k) based on criteria entered by the course instructor. The course instructor typically designs the difference between the first course content 134(k) and the second course content 136(k) in order to learn something specific about how students respond to particular aspects of the learning module 132(k) or the MOOC as a whole.

As an example of different versions of a learning module 132(k), suppose that the MOOC is a mathematics course and the learning module 132(k) includes, as first course content 134(k), 5 video lectures and a text document that contains homework exercises. Suppose further that the course instructor would like to try out a new derivation of a mathematical proof seen in one of the videos of the first course content 134(k). The course instructor may then create the second course content 136(k) by replacing that video of the first course content 134(k) with a new video demonstrating the new derivation of the mathematical proof. Further, the text document of the second course content 136(k) may also be changed to reflect the teachings of the new mathematical proof.

The student population data 140 includes records identifying each of the students initially enrolled in the MOOC. The records of the student population data 140 includes, for each student, identifying information identifying that student, a status indicating which learning modules 132(1), . . . , 132(N) that student has completed, and other descriptors that may be used by the A/B testing computer 120 (e.g., gender, age, and income).

The A/B testing manager 150 is configured to set up A/B experiments and record results of the A/B experiments. In setting up the A/B experiments, the A/B testing manager 150 assigns students identified in the student population data 140 (i.e., enrolled in the MOOC) for each of the learning modules to a version of the course content in that learning module, i.e., the students will experience with first course content 134(k) or second course content 136(k). The assignment of students to the first version 134(k) or the second version 136(k) of the course content is performed for each of the learning modules independently. To this end, in some implementations, including that pictured in FIG. 1, the A/B testing manager 150 includes a random number generation manager 152.

The random number generation manager 152 is configured to output a set of student identifiers for any given learning module 132(k) that identifies students that will use the first course content 134(k) or the second course content 136(k). For example, suppose that each of the students of the student population are identified by numbers 1, 2, 3, . . . , M, where M is the number of students enrolled in the MOOC. In this case, the random number generation manager 152 may generate M/2 unique numbers between 1 and M to produce identifiers 154(k) identifying the students from the student population 140 that will use the first course content 134(k) and identifiers 156(k) identifying the other students of the student population that will use the second course content 136(k). The random number generation manager 152 performs such a random number generation once per learning module i.e., N times. Random number generators that may be used by the random number generation manager 152 to produce the randomly-generated identifiers may include any integer- or floating-point-based generators such as a linear congruential generator or those based on physical processes such as clock drift.

The A/B experiments described above are independent of one another. Accordingly, the results of one A/B experiment should not affect results of subsequent A/B experiments. Nevertheless, there are situations where true independence may not be achieved. For example, suppose that a student of the student population stops performing course-related activities after experiencing some learning module. Is that student stopped as a result of the A/B experiment (e.g., dissatisfaction with the material, poor performance on an altered quiz), then there will be one fewer student participating in subsequent experiments.

That said, the A/B experiments may be assumed to be completely independent from one another. Along these lines, this independence may be exploited to limit the number of experimental results that might result from the large student population. For example, if the A/B experiments were dependent on one another, then one might construct a tree of possibilities for each student, resulting in 2^{N} possible outcomes per student. But because the A/B experiments are independent, the results are focused on the large (i.e., the MOOC and the learning modules) rather than individual students, and the students are randomly assigned to course content versions, there are only N possible outcomes. Such an arrangement of the experiments is advantageous for MOOCs in general because the number of students typically enrolled in a MOOC may be as many as 1,000 to 10,000. Accordingly, the amount of data is limited on the one hand through independence of the A/B experiments, and on the other hand there is still enough data to provide meaningful statistical analyses from which a course instructor may draw conclusions about the MOOC and its content.

In some implementations, not all of the learning modules 132(1), . . . , 132(N) have different course content versions for A/B experiments. In this case, there will be at least one learning module, e.g., learning module 132(1), in which all of the students of the student population will learn the exact same material.

The short-timescale evaluation manager 160 is configured to analyze data related to metrics measuring changes in the course between learning modules. For example, suppose that two learning modules are provided each week. For a particular learning module, e.g., learning module 132(k), one possible result 162(k), i.e., metric being measured is the number of students who have completed the course materials of the subsequent learning module. Another possible metric is the average quiz grade in that learning module.

The long-timescale evaluation manager 170 is configured to analyze data related to metrics measuring changes in the course as a whole. One possible result 172, i.e., metric being measured is the difference in the number of students initially enrolled and the number of students completing the course material of the final learning module 132(N).

Based on the short-timescale results 162(1), . . . , 162(N) and the long-timescale results 172, the course instructor may make decisions related to changes in the course content of the MOOC in the future. For example, the course instructor may implement statistical analyses of the short-timescale results 162(1), . . . , 162(N) to determine whether a change in the course content improved student retention.

In some implementations, the memory 126 can be any type of memory such as a random-access memory, a disk drive memory, flash memory, and/or so forth. In some implementations, the memory 126 can be implemented as more than one memory component (e.g., more than one RAM component or disk drive memory) associated with the components of the A/B testing computer 120. In some implementations, the memory 126 can be a database memory. In some implementations, the memory 126 can be, or can include, a non-local memory. For example, the memory 126 can be, or can include, a memory shared by multiple devices (not shown). In some implementations, the memory 126 can be associated with a server device (not shown) within a network and configured to serve the components of the A/B testing computer 120.

The components (e.g., modules, processing units 124) of the A/B testing computer 120 can be configured to operate based on one or more platforms (e.g., one or more similar or different platforms) that can include one or more types of hardware, software, firmware, operating systems, runtime libraries, and/or so forth. In some implementations, the components of the A/B testing computer 120 can be configured to operate within a cluster of devices (e.g., a server farm). In such an implementation, the functionality and processing of the components of the A/B testing computer 120 can be distributed to several devices of the cluster of devices.

The components of the A/B testing computer 120 can be, or can include, any type of hardware and/or software configured to process attributes. In some implementations, one or more portions of the components shown in the components of the A/B testing computer 120 in FIG. 1 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the A/B testing computer 120 can be, or can include, a software module configured for execution by at least one processor (not shown). In some implementations, the functionality of the components can be included in different modules and/or different components than those shown in FIG. 1.

Although not shown, in some implementations, the components of the A/B testing computer 120 (or portions thereof) can be configured to operate within, for example, a data center (e.g., a cloud computing environment), a computer system, one or more server/host devices, and/or so forth. In some implementations, the components of the A/B testing computer 120 (or portions thereof) can be configured to operate within a network. Thus, the components of the A/B testing computer 120 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some embodiments, one or more of the components of the A/B testing computer 120 can be, or can include, processors configured to process instructions stored in a memory. For example, the electronic document acquisition manager 130 (and/or a portion thereof), the semantic embedding model manager 140 (and/or a portion thereof), the query manager 150 (and/or a portion thereof), the similarity score manager 160, (and/or a portion thereof), and the selection manager 170 (and/or a portion thereof) can be a combination of a processor and a memory configured to execute instructions related to a process to implement one or more functions.

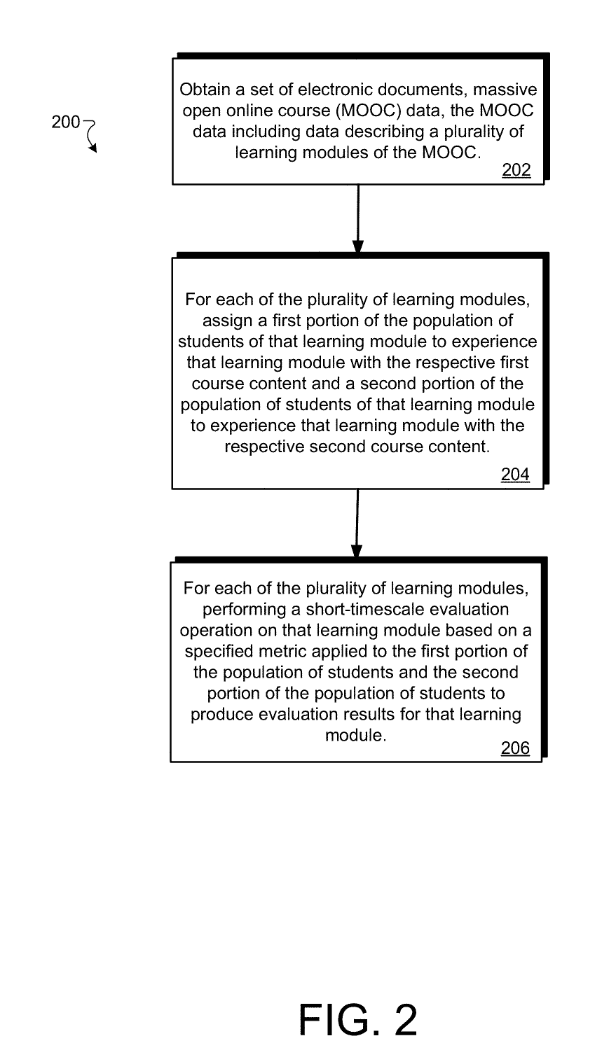

FIG. 2 is a flow chart that illustrates an example method 200. The method 200 may be performed by software constructs described in connection with FIG. 1, which reside in memory 126 of the A/B testing computer 120 and are run by the set of processing units 124.

At 202, the A/B testing computer 120 obtains MOOC data and data describing a population of students enrolled in the MOOC. The MOOC data includes data describing a plurality of learning modules of the MOOC. Each of the plurality of learning modules includes respective first course content and second course content. Again, the second course content typically contains a single change from the first course content, e.g., a change in a method of deriving a mathematical proof.

At 204, the A/B testing computer 120 assigns, for each of the plurality of learning modules, a first portion of the population of students to experience that learning module with the respective first course content and a second portion of the population of students to experience that learning module with the respective second course content. It should be noted that the assignment of the first and second portions of the students to the first and second course content does not necessarily occur all at once, but can occur over time as the MOOC progresses. It should also be noted that the students may be assigned according to the output of a random number generator so that there may be very little correlation between the first portions of students and the second portions of students of different learning modules.

At 206, the A/B testing computer performs, for each of the plurality of learning modules, a short-timescale evaluation operation on that learning module based on a specified metric applied to the first portion of the population of students and the second portion of the population of students to produce evaluation results for that learning module For example, the short-timescale evaluation manager 160 may evaluate a number of students of the first portion and the second potion completing the tasks of a current learning module that completed the tasks associated with the subsequent learning module.

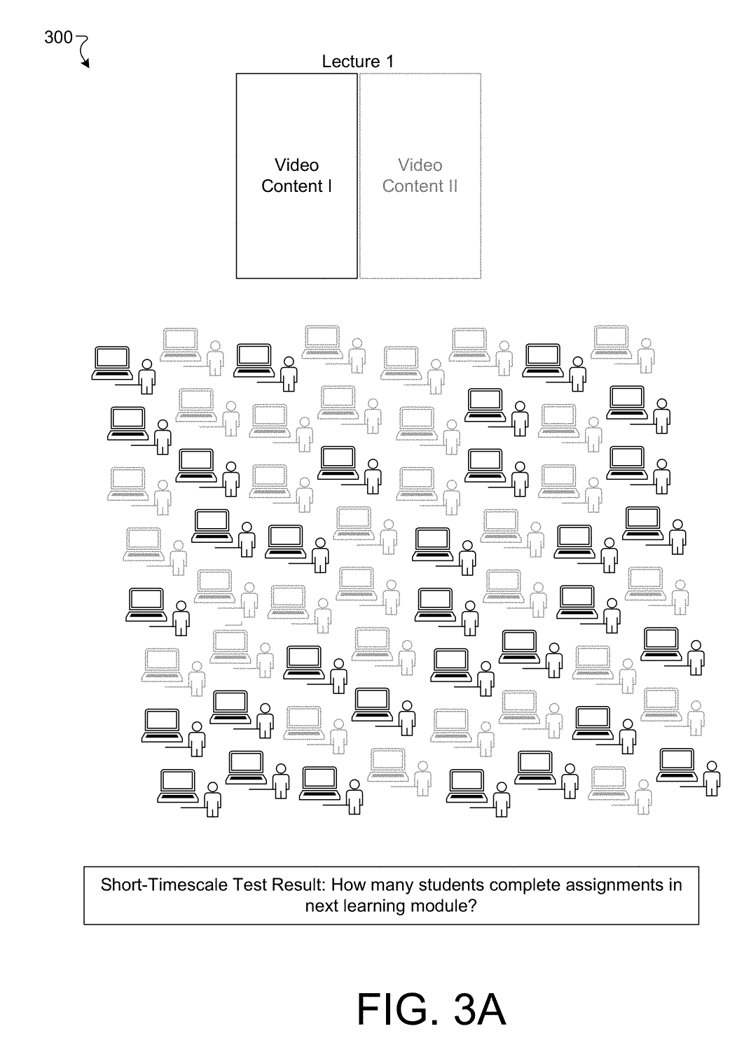

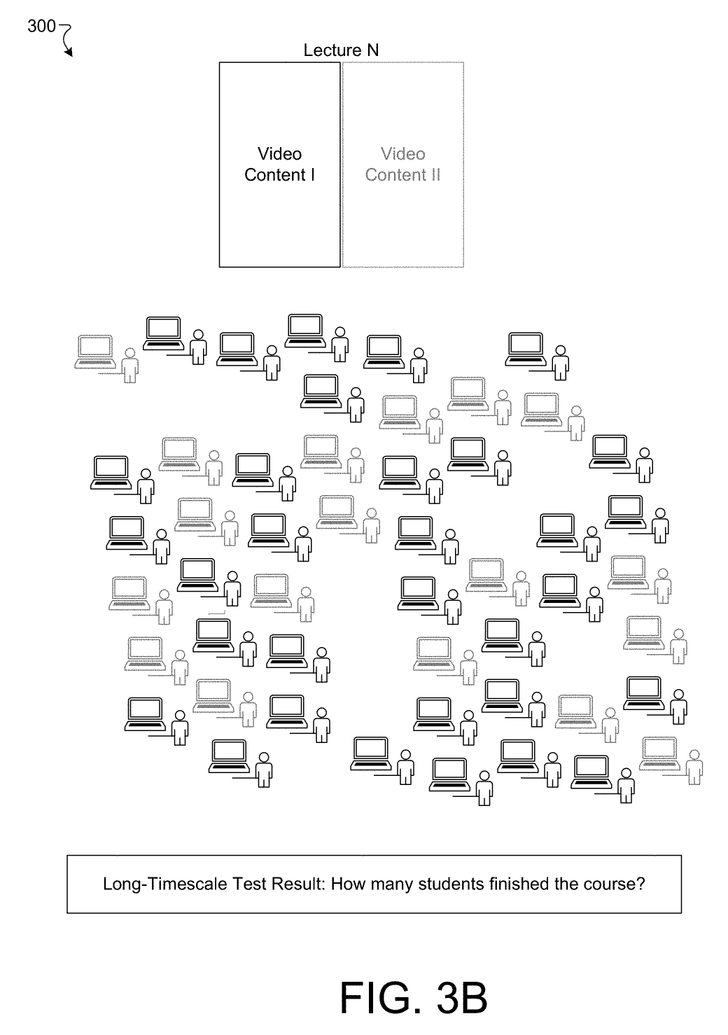

FIG. 3A is a diagram illustrating an example MOOC 300 according to the above-described improved techniques. In FIG. 3A, there is a population of students initially enrolled in a MOOC, each represented by a user at a computer. The population of students as shown in FIG. 3A has been split into a first portion and a second portion according to a random number generator built into, e.g., the AB testing computer 120. The first portion is shown in FIG. 3A as dark-colored and the second portion is shown as light-colored. It should be noted that the students themselves do not know they are part of an experiment and are unaware of any versions of the course content.

In the example shown in FIG. 3A, the first portion of students watches the first video content (“Video Content I”) as part of the first course content. To carry over an example discussed above, the first video content might show the course instructor teaching a method of formulating a mathematical proof. In about the same time frame, the second portion of students watches the second video content (“Video Content II”), which might show a new method of formulating the mathematical proof.

An advantage of the above-described improved techniques lies in its flexible timescale. If the course could only be evaluated as a whole, as is done conventionally, then the course instructor would have to wait for several weeks or longer before understanding the impact of a single change to the course. Further, evaluating several different changes to the course would take several times longer. In contrast, the improved techniques allow the course instructor to measure the impact of changes both between consecutive lectures or learning modules and over the MOOC as a whole.

In the example shown in FIG. 3A, the short-timescale evaluation involves comparing the number of students that complete the tasks in the next learning module to those that completed tasks in the current learning module. For example, some students that may have been discouraged by the method of proof in the first content may not be discouraged by the method of proof in the second content (and vice-versa). Other metrics include average quiz grades received by the first and second portion, percent homework completion, and the like.

FIG. 3B is a diagram illustrating the example MOOC 300 in the timeframe of the final learning module. The portions are represented as in FIG. 3A (first portion dark, second portion light). There are fewer students spearing in FIG. 3A; presumably, some students have formally dropped out of the class and are no longer being assigned to one portion or the other. (This is by no means a requirement and in some implementations, all students are counted in all learning modules.)

Accordingly, a long-timescale evaluation may be made as the MOOC is finishing. For example, one metric for evaluation may involve counting the total number of students who are still enrolled in the course. Alternatively, the metric may involve counting the number of students who complete the tasks of the final learning module.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device (computer-readable medium, a non-transitory computer-readable storage medium, a tangible computer-readable storage medium) or in a propagated signal, for processing by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be processed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the processing of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user ca provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method, comprising:
obtaining, by processing circuitry of a computer, massive open online course (MOOC) data and data describing a population of students enrolled in the MOOC, the MOOC data including data describing a plurality of learning modules of the MOOC, each of the plurality of learning modules including respective first course content and second course content;
for each of the plurality of learning modules:
assigning a first portion of the population of students to experience that learning module with the respective first course content and a second portion of the population of students to experience that learning module with the respective second course content; and
performing a short-timescale evaluation operation on that learning module based on a specified metric applied to the first portion of the population of students and the second portion of the population of students to produce evaluation results for that learning module.

2. The method as in claim 1, wherein assigning the first portion of the population of students includes performing a random number generating operation to produce random numbers identifying the first portion of the population of students.

3. The method as in claim 2, further comprising designating each student of the population of students as belonging to one of a plurality of specified groups;
wherein assigning the first portion of the population of students further includes for each of the plurality of groups, performing the random number generating operation for that group;
wherein the first portion of the population of students is identified by an aggregation of random numbers produced by the random number generation operation performed for each of the plurality of groups.

4. The method as in claim 1, wherein each of the plurality of learning modules includes a lecture provided over a single period of time; and
wherein the respective first course content and the respective second course content of each of the plurality of learning modules includes video content.

5. The method as in claim 4, wherein the respective second course content of each of the plurality of learning modules has additional content not shown in the respective first course content of that learning module.

6. The method as in claim 4, wherein performing the short-timescale evaluation operation on each of the plurality of learning modules includes tracking a first number of students of the first portion of the population of students that are present in a subsequent lecture and a second number of students of the second portion of the population of students that are present in the subsequent lecture.

7. The method as in claim 1, further comprising performing a long-timescale evaluation operation on the MOOC based on the evaluation results for each of the learning modules of the MOOC to produce an evaluation result for the MOOC as a whole.

8. The method as in claim 7, wherein performing the long-timescale evaluation operation on the MOOC includes verifying whether each student of the population of students completed the MOOC.

9. A computer program product comprising a nontransitive storage medium, the computer program product including code that, when executed by processing circuitry of a computer, causes the processing circuitry to perform a method, the method comprising:
massive open online course (MOOC) data and data describing a population of students enrolled in the MOOC, the MOOC data including data describing a plurality of learning modules of the MOOC, each of the plurality of learning modules including respective first course content and second course content;
for each of the plurality of learning modules:
assigning a first portion of the population of students to experience that learning module with the respective first course content and a second portion of the population of students to experience that learning module with the respective second course content; and
performing a short-timescale evaluation operation on that learning module based on a specified metric applied to the first portion of the population of students and the second portion of the population of students to produce evaluation results for that learning module.

10. The computer program product as in claim 9, wherein assigning the first portion of the population of students includes performing a random number generating operation to produce random numbers identifying the first portion of the population of students.

11. The computer program product as in claim 10, wherein the method further comprises designating each student of the population of students as belonging to one of a plurality of specified groups;
wherein assigning the first portion of the population of students further includes for each of the plurality of groups, performing the random number generating operation for that group;
wherein the first portion of the population of students is identified by an aggregation of random numbers produced by the random number generation operation performed for each of the plurality of groups.

12. The computer program product as in claim 9, wherein each of the plurality of learning modules includes a lecture provided over a single period of time; and
wherein the respective first course content and the respective second course content of each of the plurality of learning modules includes video content.

13. The computer program product as in claim 12, wherein the respective second course content of each of the plurality of learning modules has additional content not shown in the respective first course content of that learning module.

14. The computer program product as in claim 12, wherein performing the short-timescale evaluation operation on each of the plurality of learning modules includes tracking a first number of students of the first portion of the population of students that are present in a subsequent lecture and a second number of students of the second portion of the population of students that are present in the subsequent lecture.

15. The method as in claim 9, wherein the method further comprises performing a long-timescale evaluation operation on the MOOC based on the evaluation results for each of the learning modules of the MOOC to produce an evaluation result for the MOOC as a whole.

16. The method as in claim 15, wherein performing the long-timescale evaluation operation on the MOOC includes verifying whether each student of the population of students completed the MOOC.

17. An electronic apparatus, comprising:
memory; and
controlling circuitry coupled to the memory, the controlling circuitry being configured to:
obtain massive open online course (MOOC) data and data describing a population of students enrolled in the MOOC, the MOOC data including data describing a plurality of learning modules of the MOOC, each of the plurality of learning modules including respective first course content and second course content;
for each of the plurality of learning modules:
assign a first portion of the population of students to experience that learning module with the respective first course content and a second portion of the population of students to experience that learning module with the respective second course content; and
perform a short-timescale evaluation operation on that learning module based on a specified metric applied to the first portion of the population of students and the second portion of the population of students to produce evaluation results for that learning module.

18. The electronic apparatus as in claim 17, wherein the controlling circuitry configured to assign the first portion of the population of students is further configured to perform a random number generating operation to produce random numbers identifying the first portion of the population of students.

19. The electronic apparatus as in claim 17, wherein each of the plurality of learning modules includes a lecture provided over a single period of time; and
wherein the respective first course content and the respective second course content of each of the plurality of learning modules includes video content.

20. The electronic apparatus as in claim 17, wherein the controlling circuitry is further configured to perform a long-timescale evaluation operation on the MOOC based on the evaluation results for each of the learning modules of the MOOC to produce an evaluation result for the MOOC as a whole.
